(19) United States
(12) Patent Application Publication
(10) Pub. No.: US 2026/0178693 A1
(43) Pub. Date: Jun. 25, 2026

(54) MATRIX BLOCK BUFFERING FOR MATRIX MULTIPLICATION OPERATIONS USING REPEATED MATRIX BLOCKS

(71) Applicant: ADVANCED MICRO DEVICES, INC., Santa Clara, CA (US)

(72) Inventors: Shubra Marwaha, Santa Clara, CA (US); Bin He, Orlando, FL (US); Subramaniam Maiyuran, Folsom, CA (US); Saikishore Reddipalli, Cupertino, CA (US)

(21) Appl. No.: 18/999,266

(22) Filed: Dec. 23, 2024

(51) Int. Cl. G06F 17/16

(52) U.S. Cl. CPC G06F 17/16

(57) ABSTRACT

An accelerator unit (AU) including vector registers and one or more processor cores is configured to schedule instructions for execution that share one or more matrix block. To this end, the AU maintains multiple tracking entries for each of one or more hardware buffers of the processor cores that indicate the vector register addresses associated with the corresponding matrix blocks loaded into the entries of the hardware buffers. When the AU schedules an instruction indicating a matrix multiplication operation for execution, the AU compares the vector register addresses indicated in the instruction to the tracking entries of a hardware buffer. In response to the vector register addresses of the instruction matching a tracking entry for the hardware buffer, the AU suppresses a read request to the vector registers and uses data from a corresponding entry of the hardware buffer to perform the matrix multiplication operation.

### BACKGROUND

To implement certain machine-learning models, some processing systems include specialized processing units, such as graphics processing units (GPUs), configured to perform dot-product operations using matrices that represent the weights and biases of the machine-learning models. To have a specialized processing unit perform such dot-product operations, a central processing unit (CPU) of the processing system sends a stream of instructions to the specialized processing unit that indicates the dot-product operations to be performed. The specialized processing unit then schedules these instructions for execution by storing data representing the matrices to be multiplied in the vector registers of the specialized processing unit. From the vector registers, the specialized processing unit performs one or more dot product operations by retrieving the matrices from the vector registers.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system that implements matrix block buffering for matrix multiplication operations using repeated matrix blocks, in accordance with some implementations.

FIG. 2 is a block diagram of an example processor core configured to buffer matrix blocks on instructions indicating repeated matrix blocks, in accordance with some implementations.

FIG. 3 is a block diagram of an example processor core architecture for tracking matrix blocks loaded into the hardware buffers of the AU, in accordance with some implementations

FIG. 4 is a flow diagram of an example method for matrix block buffering for matrix multiplication operations using repeated matrix blocks, in accordance with some implementations.

### DETAILED DESCRIPTION

Systems and techniques disclosed herein include a processing system configured to implement one or more machine-learning models. For example, while executing certain applications, the processing system is configured to implement machine-learning models such as supervised machine-learning models, unsupervised machine-learning models, reinforcement machine-learning models, neural networks, deep-learning neural networks, large language models, multimedia large language models, and the like that are configured to generate data for the executing applications. These machine-learning models, for example, require the processing system to perform matrix multiplication operations (e.g., dot product operations) using matrices representing weights, biases, scales, and the like of a corresponding machine-learning model. To perform matrix multiplication operations, the processing system includes an accelerator unit (AU) that includes one or more cores that each operate as one or more compute units. A compute unit, for example, includes one or more single instruction, multiple data (SIMD) units having ALU circuitry that includes one or more arithmetic logic units (ALUs) configured to perform a matrix multiplication operation using data stored in vector registers included in or otherwise connected to the SIMD unit, hardware buffers of the AU, or both. However, the matrices to be multiplied for a machine-learning model are likely to be larger than the cores of the AU can multiply at once. For example, certain matrices to be multiplied are represented by data larger than the ALU circuitry of a SIMD unit of a core can multiply at once.

As such, to implement a machine-learning model, the processing system further includes a memory that stores data (e.g., program code) representing one or more instructions to be performed for the machine-learning models. These instructions, for example, each indicate respective portions of matrices to be multiplied based on the size of data the ALU circuitry of the core is able to multiply at once. For example, to multiply a first matrix by a second matrix, data in the memory indicates instructions that each includes a matrix multiplication operation for a corresponding portion of the first matrix and a corresponding portion of the second matrix. These portions of a matrix indicated in the instructions, also referred to herein as “matrix blocks,” each include at least a portion of a corresponding row or column of a matrix that is based on the size of the hardware buffer of the cores of the AU. As an example, to multiply a 32×32 first matrix by a 32×32 second matrix, each instruction includes a matrix block indicating a respective set of 16 elements of a corresponding row of the first matrix and a matrix block indicating a respective set of 16 elements of a corresponding column of the second matrix.

Further, the processing system includes a central processing unit (e.g., CPU) configured to provide a stream of these instructions to the AU. Based on receiving the instructions, a command processor of the AU schedules the instructions for execution at corresponding compute units. As an example, when allocating an instruction to a compute unit for execution, the AU stores data representing the matrix blocks indicated in the instruction in the vector registers of the core. When the core executes the instructions, scheduling circuitry of the core reads the matrix blocks from the vector registers and provides these matrix blocks to the ALU circuitry of the SIMD unit which then performs the matrix multiplication operation indicated in the instruction. Further, the core stores each read-out matrix block into a corresponding hardware buffer included in or otherwise connected to the core. However, accessing the vector registers to read matrix data for each instruction to be executed increases the time needed to execute the instructions due to the read-and-write cycle required to read data from the vector registers, provide the data to the ALU circuitry, and store the data in the hardware buffers. As such, to help reduce the amount of data to be read from the vector registers, the AU is configured to buffer matrix blocks at the AU for matrix multiplication operations using repeated matrix blocks. As an example, within the data (e.g., program code) stored in the memory of the processing system, the instructions are arranged such that groups of two or more instructions to be executed share a matrix block to be used in respective matrix multiplication operations. Such groups of two or more instructions to be executed that share a matrix block are also referred to herein as an “instruction group.” Additionally, each instruction in an instruction group includes a reuse indicator that indicates whether the instruction uses a matrix block that is also used by a subsequent instruction (e.g., instruction to be executed later) of the instruction group. That is, whether the instruction indicates a matrix multiplication operation that uses a matrix block that is used in a matrix multiplication operation of an instruction to be executed later.

The CPU then provides an instruction stream to the AU that includes the instruction groups based on the data stored in the memory. In response to receiving the instruction stream, a command processor allocates the instructions in the instruction stream to the cores of the AU for execution such that the instruction groups are allocated to respective cores. When allocating instructions including one or more instruction groups to a core, the command processor stores data representing the matrix blocks indicated in the instructions in the vector registers of the core. Additionally, the command processor modifies and stores the instructions in the vector registers such that the instructions each indicate a corresponding matrix multiplication operation is to be performed using data from corresponding vector register addresses storing respective matrix blocks. To execute these instructions allocated to a core, scheduling circuitry of the core schedules instructions at respective SIMD units for execution. For example, the scheduling circuitry schedules the first instruction of an instruction group to a SIMD unit for execution. When scheduling this first instruction, the scheduling circuitry reads the matrix blocks from the vector register addresses indicated in the first instruction, provides the matrix blocks to the ALU circuitry, and stores the matrix blocks in the hardware buffers of the core. A SIMD unit, for example, includes or is otherwise connected to two or more hardware buffers each configured to store data representing respective matrix blocks to be used in multiplication operations for allocated instructions. As an example, each hardware buffer is configured to store data representing two or more matrix blocks. To manage the data loaded into each hardware buffer, each hardware buffer is connected to buffer control circuitry configured to monitor the data provided to the ALU circuitry of the SIMD unit from the vector registers. In response to data representing matrix blocks being provided to the ALU circuitry of a SIMD unit, the buffer control circuitry loads data representing the matrix blocks into the hardware registers associated with the SIMD unit. For example, the buffer control circuitry loads data representing a first matrix provided to the ALU circuity into a first hardware buffer and data representing a second matrix provided to the ALU circuitry into a second hardware buffer.

Further, the buffer control circuitry is configured to maintain a tracking set for each hardware buffer of the SIMD units of the core. A tracking set, for example, includes a respective tracking entry for each matrix block (e.g., a set of data representing a matrix block) loaded into an associated entry of a hardware buffer. For example, in response to data (e.g., a matrix block) being loaded into an entry of a hardware buffer, the tracking circuitry updates a tracking entry of the tracking set associated with the entry of the hardware buffer. Each of these tracking entries includes, for example, data indicating the vector register addresses from which the matrix block was read out (e.g., the vector register addresses the data was read out before being provided to the ALU circuitry), whether the matrix block was modified before being stored in the entry of the hardware buffer, the age of the matrix block (e.g., data indicating when the matrix block was loaded into the hardware buffer), and whether the matrix block is to be reused for another instruction to be executed. As an example, based on a first instruction that indicates a first matrix block at a set of vector register addresses and that the first matrix block is to be used by a later instruction, the buffer control circuitry loads the first matrix block into an entry of the hardware buffer. After the first matrix block has been loaded, the buffer control circuitry updates a tracking entry of the tracking set for the entry of the hardware buffer to indicate the set of vector register addresses and that the matrix block is to be reused for a later instruction. If a hardware buffer is full (e.g., has no space to store another matrix block) when the buffer control circuitry goes to load a matrix block into the hardware buffer, the buffer control circuitry is configured to evict data from an entry of the hardware buffer based on the tracking set of the hardware buffer before loading the matrix block. For example, the buffer control circuitry is configured to evict the oldest entry that is not identified to be reused as indicated by the tracking set. As an example, the buffer control circuitry checks the tracking set to determine the tracking entry that identifies the oldest entry that is not identified to be reused and then evicts the entry associated with this tracking entry. If no tracking entries of the tracking set indicate that an entry is not to be reused, the buffer control circuitry then evicts the oldest entry that is indicated to be reused. In this way, the buffer control circuitry is configured to maintain the entries of the hardware buffers such that the hardware buffers store matrix blocks indicated to be reused for matrix multiplication operations.

When scheduling a second instruction (e.g., an instruction after an initially scheduled instruction) of an instruction group at the SIMD unit, the scheduling circuitry is configured to provide data indicated in the second instruction to the ALU circuitry of the SIMD unit based on whether a matrix block from the first instruction is to be reused. For example, the scheduling circuitry first compares the vector register addresses indicated in the second instruction to the vector register addresses indicated in the tracking entries of the tracking set associated with the hardware buffers of the SIMD unit to determine whether a matrix block from the first instruction is reused for the second instruction. Based on the vector register addresses indicated in the instruction matching the vector register addresses indicated in a tracking entry and based on the matching tracking entry indicating the matrix block is unmodified, the scheduling circuitry determines that the matrix block stored in the hardware buffer associated with the matching tracking entry is reused for the second instruction. Because the matrix block stored in the hardware buffer associated with the matching tracking entry is reused for the second instruction, the scheduling circuitry does not read data from these vector register addresses and provides the data stored in the corresponding entry of a hardware buffer to the ALU circuitry. Further, based on the vector register addresses indicated in the instruction not matching any tracking entry of the hardware buffers or based on a matching tracking entry indicating the matrix block was changed, the scheduling circuitry determines that the matrix block stored in the hardware buffer associated with the matching tracking entry is not reused for the second instruction. Because the matrix block stored in the hardware buffer associated with the matching tracking entry is not reused for the second instruction, the scheduling circuitry reads data from the vector register addresses indicated in the instruction and provides the data to the ALU circuitry. The buffer control circuitry then loads this data into an entry of a corresponding hardware buffer. In this way, the processing system is configured to buffer matrix blocks that are used in multiple matrix multiplication operations. Due to these matrix blocks being buffered, the processing system suppresses read requests to the vector registers for these buffered matrices which reduces the number of read requests needed to implement a machine-learning model and reduces the overall time needed to implement the machine-learning model. As such, the overall processing efficiency of the processing system is improved when implementing the machine-learning model.

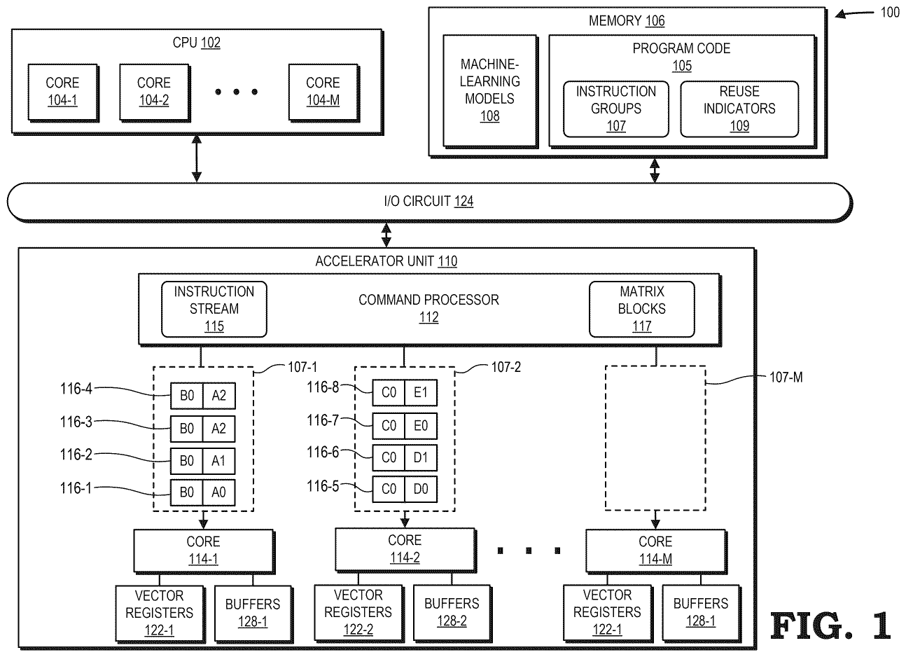

Referring now to FIG. 1, a processing system 100 configured to implement matrix block buffering for matrix multiplication operations is presented, in accordance with some implementations. According to implementations, processing system 100 is configured to execute applications that require processing system 100 to implement one or more machine-learning models 108 that include one or more supervised machine-learning models, unsupervised machine-learning models, reinforcement machine-learning models, neural networks, deep-learning neural networks, large language models, multimedia large language models, and the like. While implementing a machine-learning model 108, processing system 100 is configured to perform one or more matrix multiplication operations using matrices representing the weights, biases, scales, or combination thereof of the machine-learning model. As an example, to perform such matrix multiplication operations, processing system 100 includes AU 110 which is configured to execute instructions so as to perform one or more matrix multiplication operations for a machine-learning model 108. To implement a machine-learning model, processing system 100 includes or otherwise has access to memory 106 that stores program code 105 for the machine-learning model 108. In some implementations, memory 106 is implemented using a non-transitory computer-readable medium, for example, a dynamic random-access memory (DRAM) while in other implementations, memory 106 is implemented using other types of memory including, for example, static random-access memory (SRAM), nonvolatile RAM, and the like. Additionally, memory 106, according to some implementations, includes an external memory implemented external to the processing units implemented in the processing system 100. Program code 105 includes, for example, compiled code (e.g., compiled binary code) indicating instructions that, when executed, cause the matrix multiplication operations to be performed for a machine-learning model 108. As an example, program code 105 includes instructions that indicate a corresponding matrix multiplication operation (e.g., matrix dot product operation, MATMUL operation) to be performed using matrices representing weights, biases, scales, or any combination thereof associated with a respective machine-learning model 108.

According to implementations, the matrix multiplication operations to be performed for a machine-learning model 108 use matrices that are too large to be multiplied at once by processing system 100. As an example, these matrices are too large for the ALU circuitry of AU 110 (e.g., circuitry including one or more ALUs and multiplexers configured to perform a matrix multiplication operation) to multiply at once. As such, the instructions indicated by program code 105 each indicate portions of respective matrices to be multiplied. As an example, for a matrix multiplication operation that multiplies a first matrix by a second matrix, the program code 105 includes two or more instructions each indicating a matrix multiplication operation that multiplies a respective portion of the first matrix by a respective portion of the second matrix. These respective portions of the matrices indicated by the instructions, for example, each include at least a portion of a row or column of a corresponding matrix. As an example, a respective portion of a matrix includes a predetermined number of elements of a row or column of a matrix. According to implementations, each portion of a matrix indicated by an instruction includes the same number of elements based on the hardware buffers of the AU 110. That is, each portion of a matrix indicated by an instruction includes a predetermined number of elements of a row or column of the matrix that are able to be stored in the entries of the hardware buffers of the AU 110, able to be used in a single matrix multiplication operation by ALU circuitry, or both. As used herein, these portions of matrices are also referred to herein as “matrix blocks.” For example, within FIG. 1 these portions of matrices indicated by the instructions are represented as matrix blocks 117.

To help schedule the execution of the instructions indicated by program code 105, in implementations, the instructions are arranged in program code 105 such that two or more instructions each indicating the same matrix block 117 are to be executed by the same core 114 of AU 110. As an example, for a matrix multiplication operation to multiply a first matrix by a second matrix, program code 105 includes a group of instructions to be performed at a core 114 that has a first instruction to be executed first that multiplies a first matrix block 117 of the first matrix by a first matrix block 117 of the second matrix, a second instruction to be executed after the first instruction that multiplies a second matrix block 117 of the first matrix by the first matrix block 117 of the second matrix, and a third instruction to executed after the second instruction that multiplies a third matrix block 117 of the first matrix by the first matrix block 117 of the second matrix. As used herein, such groups of instructions to be executed at the same core 114 and indicating the same matrix block 117 are represented in FIG. 1 as “instruction groups 107.” Further, each instruction in the program code 105 includes a reuse indicator 109 that indicates whether a certain matrix block 117 used in the matrix multiplication operation of the instruction is to be used in a matrix multiplication operation of another instruction to be executed at the same core 114 (e.g., in a matrix multiplication operation of another instruction in the same instruction group 107). That is, a reuse indicator 109 includes, for example, data (e.g., a flag) or metadata that indicates whether a certain matrix block 117 indicated by the instruction is to be used by another instruction in the same instruction group 107.

To execute instructions in these instruction groups 107, processing system 100 is configured to provide a stream of instructions indicating the instruction groups 107 to AU 110. For example, according to implementations, processing system 100 includes CPU 102 configured to provide an instruction stream 115 indicating instruction groups 107 to AU 110. As an example, in implementations, CPU 102 is configured to maintain a command queue (e.g., a circular queue) that stores a set of instructions indicating one or more instruction groups 107. After the command queue is ready to be consumed, AU 110 retrieves the set of instructions for the command queue which forms the instruction stream 115 provided to AU 110. To maintain this command queue, CPU 102 includes one or more processor cores 104 that implement a plurality of processor cores 104-1 to 104-M configured to execute instructions concurrently or in parallel. Though in the example implementation illustrated in FIG. 1, three processor cores (104-1, 104-2, 104-M) are presented representing an M integer number of cores, the number of processor cores 104 implemented in the CPU 102 is a matter of design choice. As such, in other implementations, the CPU 102 can include any non-zero integer number of processor cores 104.

AU 110 is configured to operate as one or more vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (e.g., field-programmable logic devices (FPGAs)), or any combination thereof. To execute one or more instructions in a received instruction stream, AU 110 implements one or more cores 114 that execute instructions concurrently or in parallel. In some implementations, one or more of the cores 114 each operate as one or more compute units that each include one or more SIMD units configured to perform matrix multiplication operations. As an example, a SIMD unit includes ALU circuitry configured to perform a multiplication operation (e.g., dot product operation) using data (e.g., matrix blocks 117) read out of vector registers 122 included in or otherwise connected to the core 114 including the SIMD unit. Though the example implementation presented in FIG. 1 shows AU 110 as including three cores (114-1, 114-2, 114-M) representing an M integer number of cores, in other implementations, AU 110 can include any non-zero integer number of cores 114 each configured to operating as one or more compute units. In some implementations, to enable communication between CPU 102 and one or more other components (e.g., AU 110, memory 106) of processing system 100, processing system 100 includes input/output (I/O) circuit 124. I/O circuit 124 includes, for example, one or more busses, memory controllers, switches (e.g., PCI switches), data fabrics, queues, buffers, or the like. As an example, I/O circuit 124 is configured to connect a command processor 112 of AU 110 to one or more processor cores 104 of CPU 102, memory 106, or both.

In response to receiving an instruction stream 115, a command processor 112 included in or otherwise connected to AU 110 first allocates respective instructions indicated in instruction stream 115 to one or more cores 114 of AU 110. Such a command processor 112, for example, includes circuitry such as one or more microprocessors, logic gates, buffers, queues, and the like configured to schedule instructions for execution by one or more cores 114. When allocating instructions from an instruction stream 115 to the cores 114, in implementations, the command processor 112 is configured to allocate each instruction in an instruction group 107 to a respective core 114. That is, from the instruction stream 115, the command processor 112 is configured to allocate groups of instructions to be executed by the same core 114. As an example, the command processor 112 allocates each instruction from a first instruction group 107-1 to a first core 114-1. This first instruction group 107-1, for example, includes a first instruction 116-1 to be executed that indicates a first matrix block 117 (e.g., B0) of a first matrix is to be multiplied by a first matrix block 117 (e.g., A0) of a second matrix; a second instruction 116-2 to be executed after the first instruction 116-1 that indicates the first matrix block 117 of the first matrix is to be multiplied by a second matrix block 117 (e.g., A1) of the second matrix; a third instruction 116-3 to be executed after the second instruction 116-2 that indicates the first matrix block 117 of the first matrix is to be multiplied by a third matrix block 117 (e.g., A2) of the second matrix; and a fourth instruction 116-4 to be executed after the third instruction 116-3 that indicates the first matrix block 117 of the first matrix is to be multiplied by a fourth matrix block 117 (e.g., A4) of the second matrix. As another example, the command processor 112 allocates each instruction from a second instruction group 107-2 to a second core 114-2. This second instruction group 107-2 includes a first instruction 116-5 to be executed that indicates a first matrix block 117 (e.g., C0) of a third matrix is to be multiplied by a first matrix block 117 (e.g., D0) of a fourth matrix; a second instruction 116-6 to be executed after the first instruction 116-5 that indicates the first matrix block 117 of the third matrix is to be multiplied by a second matrix block 117 (e.g., D1) of the fourth matrix; a third instruction 116-7 to be executed after the second instruction 116-6 that indicates the first matrix block 117 of the third matrix is to be multiplied by a first matrix block 117 (e.g., E0) of a fifth matrix; and a fourth instruction 116-8 to be executed after the third instruction 116-7 that indicates the first matrix block 117 of the third matrix is to be multiplied by a second matrix block 117 (e.g., E1) of the fifth matrix.

According to implementations, each core 114 of AU 110 includes or is otherwise connected to a respective set of vector registers (122-1, 122-2, 122-M). Each set of vector registers 122, for example, includes a set of addresses (e.g., vector register addresses) configured to store data used in the execution of one or more instructions. As an example, based on command processor 112 allocating the instructions 116 in an instruction group 107 to a core 114, the command processor 112 is configured to store data associated with the instructions 116, such as instructions, operands, values, and the like, in the vector registers 122 associated with the core 114. In implementations, the command processor 112 stores data representing the matrix blocks 117 indicated in the instructions 116 allocated to the core 114 in a set of vector register addresses of the vector registers 122. Additionally, in the vector registers 122, the command processor 112 modifies and stores the allocated instructions 116 such that the instructions 116 each indicate a multiplication operation is to be performed using data at corresponding vector register addresses (e.g., the vector registers storing the matrix blocks 117). According to implementations, each core 114 includes one or more hardware buffers (128-1, 128-2, 128-N) associated with the set of vector registers 122 of the core 114. As an example, in some implementations, each core 114 includes two hardware buffers 128 for a set of vector registers 122 (e.g., one hardware buffer 128 for odd vector registers 122 and one hardware buffer 128 for even vector registers 122). In implementations, each hardware buffer 128 includes two or more entries each configured to store data (e.g., matrix blocks 117) read out of the vector registers 122 associated with the hardware buffer 128.

For example, after an instruction 116 has been allocated to a core 114, scheduling circuitry of the core 114 schedules the instruction 116 for execution by a SIMD unit of the core 114. To this end, the scheduling circuitry first retrieves the instruction from the vector registers 122 with the instruction indicating that a first matrix multiplication operation is to be performed using data at certain vector register addresses. The scheduling circuitry then reads the data (e.g., matrix blocks 117) out of the indicated vector register addresses and provides this read-out data to the ALU circuitry of the SIMD unit. Additionally, for each matrix block 117 read out of the vector registers 122, the scheduling circuitry loads data representing the matrix block 117 into a corresponding hardware buffer 128 associated with the vector registers 122. For example, in implementations, the core 114 includes buffer control circuitry configured to load data representing matrix blocks 117 provided to the ALU circuitry into respective entries of corresponding hardware buffers 128. Additionally, this buffer control circuitry is configured to maintain a tracking set for each hardware buffer 128 with each tracking set including a tracking entry for each entry of the hardware buffer 128. These tracking entries, for example, each indicate the vector register addresses from which the data (e.g., matrix block 117) loaded into the entry was read, whether the data loaded into the entry was modified before being stored in the entry of the hardware buffer 128, an age of the data loaded into the entry of the hardware buffer 128 (e.g., data indicating when the data was loaded), and whether the data is to be reused for another instruction 116 to be executed at the core 114. As an example, based on a scheduled instruction 116 that indicates a set of vector register addresses, the buffer control circuitry first loads data representing the matrix block 117 at this set of vector register addresses into an entry of a corresponding hardware buffer 128. The buffer control circuitry then updates the tracking entry corresponding to the entry to indicate this set of vector register addresses, whether the data representing the matrix block 117 was modified before being loaded into the hardware buffer 128, when the data representing the matrix block 117 was loaded (e.g., a position in an order in which data was loaded into the entries of the hardware buffer 128), and whether the matrix block 117 is to be reused by another instruction as indicated by the reuse indicator 109 of the instruction that caused the matrix block 117 to be loaded into the hardware buffer 128.

In implementations, in response to a hardware buffer 128 being full (e.g., each entry of the hardware buffer 128 storing data representing a matrix block 117) when the buffer control circuitry goes to load data representing a matrix block 117 into the hardware buffer 128, the buffer control circuitry is configured to evict an entry based on the tracking set associated with the hardware buffer 128. As an example, based on the tracking entries of the tracking set, the buffer control circuitry first determines which entries store a matrix block 117 indicated to not be reused by another instruction. From the entries storing a matrix block 117 indicated to not be reused by another instruction, the buffer control circuitry then evicts data from the entry that includes the oldest data (e.g., data loaded the earliest) as indicated by the tracking entries. Further, in response to the tracking entries indicating that each entry includes a matrix block 117 that is to be reused, the buffer control circuitry evicts data from the entry in the hardware buffer 128 that includes the oldest data as indicated by the tracking entries. By evicting entries from the hardware buffers 128 in this way, the buffer control circuitry helps maintain the entries of the hardware buffers 128 that store matrix blocks 117 that are reused for subsequent matrix multiplication operations.

According to implementations, after the ALU circuitry of the SIMD unit executes the matrix multiplication operation for a first allocated instruction 116 using the matrix blocks 117 read out of the vector registers 122, the SIMD unit executes a second instruction 116 allocated to the core 114 by having the scheduling circuitry retrieve a second instruction from the vector registers 122 that indicates a second matrix multiplication operation is to be performed using data at certain vector register addresses. Before the scheduling circuitry retrieves the matrix blocks 117 from these vector registers 122, the scheduling circuitry first compares the vector register addresses indicated in the retrieved second instruction to the tracking entries of the tracking sets for the hardware buffers 128 of the core 114. Based on the vector register addresses in the retrieved instruction matching the vector register addresses in a tracking entry of a tracking set associated with a hardware buffer 128 and based on the tracking entry indicating that the matrix block 117 was not modified before being loaded into an entry of the hardware buffer 128, the scheduling circuitry determines that the matrix block 117 is being reused (e.g., has already been loaded into the hardware buffers 128 during a previous instruction). Due to the matrix block 117 block being reused, the scheduling circuitry does not again read out the matrix block 117 from the vector registers 122 and instead provides the matrix block 117 from the entry of the hardware buffer 128 corresponding to the matched tracking entry to the ALU circuitry. Further, based on the vector register addresses in the retrieved instruction not matching the vector register addresses in any tracking entry of a tracking set associated with the hardware buffers 128 of the core 114 or based on a matched tracking entry indicating that the matrix block 117 was modified before being loaded into the hardware buffer 128, the scheduling circuitry determines that a new matrix block 117 is needed, reads the matrix block 117 from the indicated vector register addresses in the vector registers 122, and provides the read-out matrix block 117 to the ALU circuitry.

After the matrix blocks 117 have been provided to the ALU circuitry, the ALU circuitry executes the matrix multiplication operation using the provided matrix blocks 117. The SIMD unit then executes a third instruction allocated to the core by again first checking the tracking sets of the hardware buffers 128 of the core 114 before providing the matrix blocks 117 to the ALU circuitry. The SIMD unit then continues to schedule instructions in this manner until each instruction allocated to the core 114 unit has been executed. In this way, processing system 100 is configured to buffer matrix blocks 117 that are used by multiple instructions 116 allocated to a core 114. That is, AU 110 buffers data representing matrix blocks 117 such that the cores 114 of AU 110 suppress vector register reads when the buffered matrix blocks 117 are reused for a subsequent instruction 116. Because the AU 110 suppresses vector register reads in this manner, the number of vector register reads is reduced which reduces the overall time and power needed to execute the instructions 116.

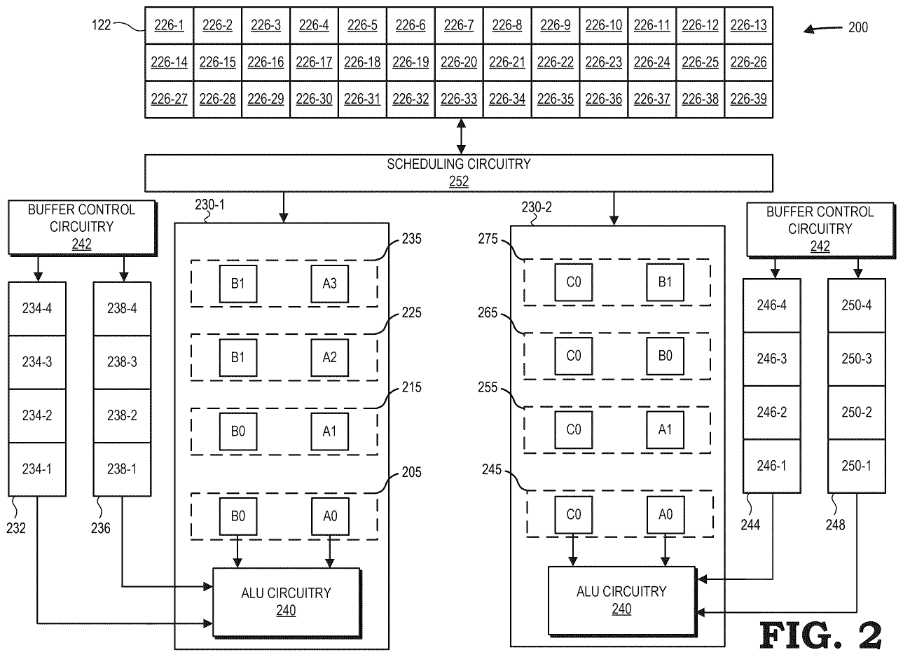

Referring now to FIG. 2, example processor core 200 configured to buffer matrix blocks on instructions indicating repeated matrix blocks is presented, in accordance with implementations. In implementations, example processor core 200 is implemented within AU 110. Example processor core 200 is configured to operate as one or more compute units that concurrently perform the same operation on different sets of data. For example, example processor core 200 includes a first SIMD unit 230-1 and a second SIMD unit 230-2. Each SIMD unit 230, for example, includes or is otherwise connected to two hardware buffers 128 configured to store data read from one or more vector registers 122 and provide such data to a corresponding ALU circuitry 240. As an example, within the implementation presented in FIG. 2, the first SIMD unit 230-1 includes or is otherwise connected to a first hardware buffer 232 and a second hardware buffer 236 and the second SIMD unit 230-2 includes or is otherwise connected to a third hardware buffer 244 and a fourth hardware buffer 248. According to implementations, each hardware buffer 232, 236, 244, 248 is configured to store data read out of corresponding sets of vector registers 122. As an example, a first hardware buffer (e.g., hardware buffer 232) is configured to store data read out of odd vector registers 122 (e.g., vector registers 122 having odd-numbered vector register addresses 226), and a second hardware buffer (e.g., hardware buffer 236) is configured to store data read out of even vector registers 122 (e.g., vector registers 122 having even-numbered vector register addresses 226). Additionally, in implementations, each hardware buffer 232, 236, 244, 248 is configured to store data representing two or more matrix blocks 117 read out of vector registers 122. As an example, each hardware buffer 232, 236, 244, 248 includes two or more entries each configured to store data representing a respective matrix block 117. For example, the first hardware buffer 232 includes entries 234-1, 234-2, 234-3, 234-4 each configured to store data representing a matrix block 117, the second hardware buffer 236 includes entries 238-1, 238-2, 238-3, 238-4 each configured to store data representing a matrix block 117, the third hardware buffer 244 includes entries 246-1, 246-2, 246-3, 246-4 each configured to store data representing a matrix block 117, and the fourth hardware buffer 248 includes entries 250-1, 250-2, 250-3, 250-4 each configured to store data representing a matrix block 117. Though the example implementation presented in FIG. 2 shows each hardware buffer 232, 236, 244, 248 as including four entries, in other implementations, each hardware buffer 244 includes any integer number of entries greater than 1.

In implementations, a corresponding ALU circuitry 240 of a SIMD unit 230 includes one or more ALUs, multiplexers, registers, or any combination thereof configured to perform one or more multiplication (e.g., dot product) operations using data read out of vector registers 122, data stored in the hardware buffers 232, 236, 244, 248 of the SIMD unit 230, or both. Though the example implementation presented in FIG. 2 shows example processor core 200 as including two SIMD units, in other implementations, example processor core 200 can include any non-zero integer number of SIMD units 230. A command processor 112 of the AU 110 including example processor core 200 is configured to allocate one or more instructions 116 of one or more instruction groups 107 to example processor core 200 for execution. That is, the command processor 112 allocates two or more instructions 116 that share one or more matrix blocks 117 to example processor core 200 for execution. To allocate these instructions 116 to example processor core 200, the command processor 112 first stores data (e.g., data from memory 106) representing the matrix blocks 117 indicated in the instructions 116 to the vector registers 122 (e.g., general purpose vector registers) included in or otherwise connected to example processor core 200. These vector registers 122, for example, include a number of vector register addresses 226. For example, in the example implementation presented in FIG. 2, vector registers 122 include vector register addresses 226-1 to 226-39. In implementations, the command processor 112 is configured to store data representing a respective matrix block 117 at a group of vector register addresses 226. As an example, the command processor 112 is configured to store data representing a matrix block 117 at vector register addresses 226-1, 226-2, 226-3, 226-4, 226-5, 226-6, 226-7, 226-8. Thought the example implementations presented in FIG. 2 shows vector registers 122 as including 39 vector register addresses (226-1, 226-2, 226-3, 226-4, 226-5, 226-6, 226-7, 226-8, 226-9, 226-10, 226-11, 226-12, 226-13, 226-14, 226-15, 226-16, 226-17, 226-18, 226-19, 226-20, 226-21, 226-22, 226-23, 226-24, 226-25, 226-26, 226-27, 226-28, 226-29, 226-30, 226-31, 226-32, 226-33, 226-34, 226-35, 226-36, 226-27, 226-38, 226-39), in other implementations, vector registers 122 can include any non-zero integer number of vector register addresses 226. After storing data representing the matrix blocks 117 at corresponding vector register addresses 226, the command processor 112 modifies the instructions 116 of the instruction group 107 such the instructions each indicate that a matrix multiplication operation is to be performed using data at corresponding vector register addresses 226 (e.g., data at corresponding vector register addresses 226 that represents the matrix blocks 117 associated with the instruction 116). To execute the instructions 116 in one or more instruction groups 107 allocated to example processor core 200, scheduling circuitry 252 included in or otherwise connected to example processor core 200 is configured to schedule the instructions 116 among the SIMD units 230 for execution.

For example, the scheduling circuitry 252 first retrieves an instruction 116 from the vector registers 122 and determines a first set of vector register addresses 226 storing a first matrix block 117 and a second set of vector register addresses 226 storing a second matrix block 117 indicated by the instruction 116. The scheduling circuitry 252 then generates a first read request indicating the first set of vector register addresses 226 storing the first matrix block 117 and a second read request indicating the second set of vector register addresses 226 storing the second matrix block 117 to the vector registers 122. After the first matrix block 117 and the second matrix block 117 are read out of the vector registers 122, the scheduling circuitry 252 provides the first matrix block 117 and the second matrix block 117 to the ALU circuitry 240. Based on these matrix blocks 117 being provided to the ALU circuitry 240, the buffer control circuitry 242 included in or otherwise connected to the core 114 loads data representing the first matrix block 117 into an entry 234 of the first hardware buffer 232 and the second matrix block 117 into an entry 238 of the second hardware buffer 236. Such buffer control circuitry 242 includes, for example, one or more microprocessors, logic gates, buffers, queues, and the like configured to manage corresponding hardware buffers.

In response to a matrix block 117 being loaded into an entry 234, 238 of the first or second hardware buffers 232, 236, the buffer control circuitry 242 updates the tracking entries corresponding to the entries 234, 238 into which the matrix blocks 117 were loaded. As an example, based on the read and write requests from the scheduling circuitry 252, the buffer control circuitry 242 determines the vector register addresses 226 from which the first and second matrix blocks 117 were read out and whether the matrix blocks 117 were modified before being loaded into the hardware buffers 232, 236. Additionally, based on the reuse indicator 109 of the instruction 116, the buffer control circuitry 242 determines whether the first matrix block 117, second matrix block 117, or both are to be reused by a subsequent instruction. From this determined information, the buffer control circuitry 242 updates the tracking entry associated with the entry 234 storing the first matrix block 117 to indicate the first set of vector register addresses 226 indicated by the instruction 116, whether the first matrix block 117 was modified, and whether the first matrix block 117 is to be reused. Likewise, based on this determined information, the buffer control circuitry 242 updates the tracking entry associated with the entry 238 storing the second matrix block 117 to indicate the second set of vector register addresses 226 indicated by the instruction 116, whether the second matrix block 117 was modified, and whether the second matrix block 117 is to be reused.

Referring to the example implementation presented in FIG. 2, the scheduling circuitry 252 is configured to schedule a first instruction of a first instruction group 107 (represented in FIG. as instruction 205) that indicates a first set of vector register addresses 226 indicating a first matrix block 117 and a second set of vector register addresses 226 indicating a second matrix block 117. To schedule the instruction 205 for execution at the first SIMD unit 230-1, the scheduling circuitry 252 reads the data at the indicated vector register addresses 226 indicated in the instruction 205 from vector registers 122 and provides the read out data (e.g., B0, A0) to the ALU circuitry 240 of the first SIMD unit 230-1. Additionally, after reading out the data from the vector registers 122, the buffer control circuitry 242 is configured to store the read out data in respective entries 234, 238 of the first hardware buffer 232 and second hardware buffer 236, respectively. For example, the buffer control circuitry 242 loads data representing a first matrix block 117 of a first matrix (e.g., B0) into a first entry 234-1 of the first hardware buffer 232 and data representing a first matrix block 117 of a second matrix (e.g., A0) into a first entry 238-1 of the second hardware buffer 232. The ALU circuitry 240 then performs a matrix multiplication operation using the read out data and stores the result (e.g., data resulting from the execution of the matrix multiplication operation) in a local data share, cache, vector register 122, or any combination thereof associated with example processor core 200. After the ALU circuitry 240 has completed the multiplication operation for the first instruction 205, the scheduling circuitry 252 schedules a second instruction from the first instruction group 107 (represented in FIG. 2 as instruction 215) by reading at least a portion of the data from the vector register addresses 226 indicated in the second instruction 215 and providing the indicated data (e.g., B0, A1) to the ALU circuitry 240. As an example, the scheduling circuitry 252 reads out data representing a second matrix block 117 of the second matrix (e.g., A1) from the vector registers 122 and provides this data to the ALU circuitry 240. Additionally, the first hardware buffer 232 is configured to provide data representing the first matrix block 117 of the second matrix (e.g., B0) from the first entry 234-1 to the ALU circuitry 240. Further, the buffer control circuitry 242 loads the read out data into a second entry 238-2 of the second hardware buffer 236. For example, the scheduling circuitry 252 loads data representing the second matrix block 117 of the second matrix (A1) into a second entry 238-2 of the second hardware buffer 236.

After the ALU circuitry 240 performs a matrix multiplication operation using the data indicated in the instruction 215, the scheduling circuitry 252 schedules a third instruction of the first instruction group 107 (represented in FIG. 2 as instruction 225) by providing the data (e.g., B0, A2) indicated in the instruction 225 to the ALU circuitry 240. For example, the scheduling circuitry 252 reads data representing the third matrix block 117 of the second matrix (e.g., A2) from the vector registers 122 and provides this data to the ALU circuitry 240. Additionally, the first hardware buffer 232 provides data representing the first matrix block 117 of the first matrix (e.g., B0) from the first entry 234-1 to the ALU circuitry 240. The buffer control circuitry 242 also loads the read out data into a third entry 238-3 of the second hardware buffer 236 such that the third entry 238-3 of the second hardware buffer 236 stores data representing the third matrix block 117 of the second matrix. Further, after the third instruction 225 is executed, the scheduling circuitry 252 schedules a fourth instruction of the first instruction group 107 (represented in FIG. 2 as instruction 225) such that data (e.g., B0, A3) indicated by the instruction 225 is provided to the ALU circuitry 240. As an example, the scheduling circuitry 252 reads data out of the vector registers 122 indicating a fourth matrix block 117 of the second matrix (e.g., A3), and provides this data to the ALU circuitry 240. Additionally, the first hardware buffer 232 provides data representing the first matrix block 117 of the first matrix from the first entry 234-1 to the ALU circuitry 240. The buffer control circuitry 242 is also configured to load the read-out data into a fourth entry 238-4 of the second hardware buffer 236 such that the fourth entry 238-4 stores data representing a fourth matrix block 117 of the second matrix (e.g., A3).

Because the instructions 116 scheduled for execution by the first SIMD unit 230-1 are within the same instruction group 107, the instructions 116 scheduled for execution reuse one or more matrix blocks 117. As an example, within the implementation presented in FIG. 2, the instructions 205, 215, 225, 235 each use the first matrix block 117 of the first matrix (e.g., B0). As another example, when scheduling a first instruction 116 of a second instruction group 107 (represented in FIG. as instruction 245) for execution at the second SIMD unit 230-2, the scheduling circuitry 252 reads data from the vector register addresses 226 indicated in the instruction 245 and provides this read out data (e.g., C0, A0) to the ALU circuitry 240. Further, the buffer control circuitry 242 loads this read out data into the hardware buffers such that a first entry 246-1 of the third hardware buffer 236 stores data indicating a first matrix block 117 of a third matrix (e.g., C0) and the first entry 250-1 of the fourth hardware buffer 248 stores data indicating the first matrix block 117 of the first matrix (e.g., A0). After the corresponding ALU circuitry 240 performs the matrix multiplication operation for the instruction 245, the scheduling circuitry 252 schedules a second instruction of the second instruction group 107 (represented in FIG. 2 as instruction 255) for execution by providing the data (e.g., C0, A1) indicated by the instruction 255 to the ALU circuitry 240. As an example, the scheduling circuitry 252 reads data representing the second matrix block 117 of the second matrix (e.g., A2) from the vector registers 122 and provides this read out data to the ALU circuitry 240 while the third hardware buffer 236 provides data representing the first matrix block 117 of the third matrix (e.g., C0) from the first entry 246-1 to the ALU circuitry 240. The buffer control circuitry 242 also loads the data representing the second matrix block 117 of the first matrix (e.g., A1) into a second entry 250-2 of the fourth hardware buffer 248. After another matrix multiplication operation is performed by ALU circuitry 240, the scheduling circuitry 252, for a third instruction of the second instruction group 107 (represented in FIG. 2 as instruction 265) provides the data (e.g., C0, B0) indicated by the instruction 265 to the ALU circuitry 240. For example, the scheduling circuitry 252 reads data representing the first matrix block 117 of the first matrix (e.g., B0) from the vector registers 122 and provides this data to the ALU circuitry 240 while the third hardware buffer 236 provides data representing the first matrix block 117 of the third matrix from the first entry 246-1 to the ALU circuitry 240. Further, the buffer control circuitry 242 loads data representing the first matrix block 117 of the second matrix (e.g., B0) into a third entry 250-3 of the fourth hardware buffer 248. Additionally, for a fourth instruction of the second instruction group 107 (represented in FIG. 2 as instruction 275), the scheduling circuitry 252 provides the data (e.g., C0, B1) indicated by the instruction 275 to the ALU circuitry 240. As an example, the scheduling circuitry 252 reads data representing the second matrix block 117 of the first matrix (e.g., B1) from the vector registers 122 and provides this data to the ALU circuitry 240 while the third hardware buffer 236 provides data representing the first matrix block 117 of the third matrix from the first entry 246-1 to the ALU circuitry 240. Additionally, the buffer control circuitry 242 loads data representing the second matrix block 117 of the second matrix (e.g., B1) into a fourth entry 250-4 of the fourth hardware buffer 248.

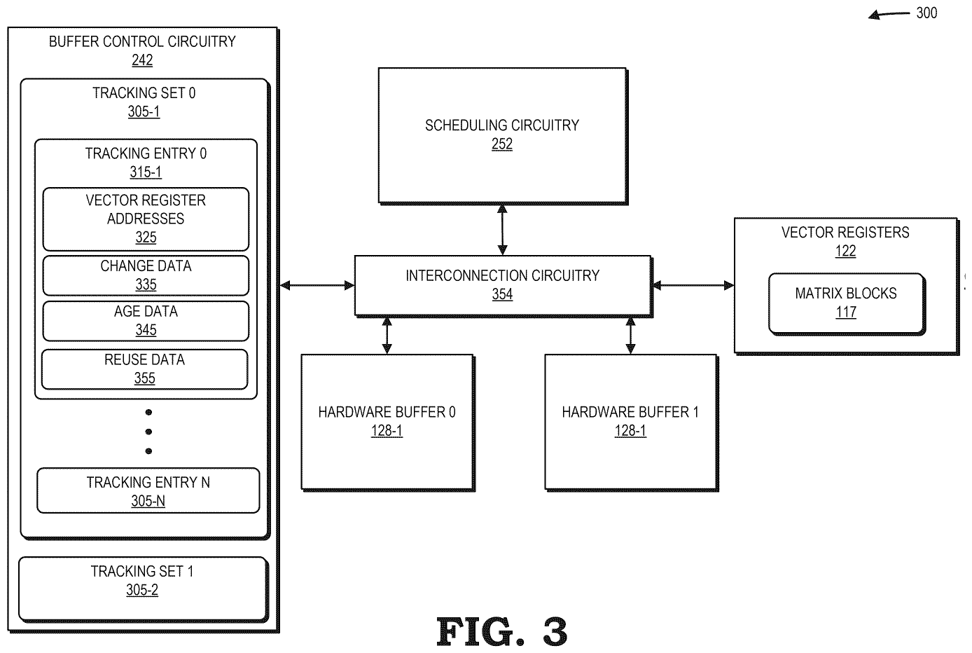

In implementations, scheduling circuitry 252 is configured to provide data to the ALU circuitry 240 based on one or more tracking sets associated with the hardware buffers 128 maintained by the buffer control circuitry 242. For example, referring now to FIG. 3, an example processor core architecture 300 for tracking matrix blocks loaded into hardware buffers of an AU is presented, in accordance with implementations. According to implementations, example processor core architecture 300 is implemented in one or more cores 114, example processor core 200, or both. To facilitate communication between components (e.g., buffer control circuitry 242, scheduling circuitry 252, hardware buffers 128, vector registers 122) of example processor core architecture 300, example processor core architecture 300 includes interconnection circuitry 354. Such interconnection circuitry 354 includes, for example, one or more busses, memory controllers, switches (e.g., PCI switches), data fabrics, queues, buffers, or the like configured to communicatively couple two or more components of example processor core architecture to one another using one or more communication protocols.

To enable a processor core to track data loaded into hardware buffers 128, the buffer control circuitry 242 is configured to maintain a respective tracking set 305 for each hardware buffer 128. For example, buffer control circuitry 242 is configured to maintain a first tracking set 305-1 (e.g., tracking set 0) for a first hardware buffer 128-1 (e.g., hardware buffer 0) and a second tracking set 305-2 (e.g., tracking set 1) for a second hardware buffer 128-2 (e.g., hardware buffer 1). Though the example implementation presented in FIG. 1 shows the buffer control circuitry 242 as maintaining a corresponding tracking set 305 for two hardware buffers (128-1, 128-2), in other implementations, the buffer control circuitry 242 is configured to maintain a corresponding tracking set 305 for any non-zero integer number of hardware buffers 128. Each tracking set 305 includes a corresponding tracking entry 315 for each entry of the hardware buffer 128 associated with the tracking set 305. Though the example implementation presented in FIG. 3 shows a tracking set 305 as including two tracking entries (315-1, 315-N) representing an N integer number of tracking entries 315, in other implementations, each tracking set 305 can include any non-zero integer number of tracking entries 315. Each tracking entry 315, for example, includes data indicating the set of vector register addresses 325, change data 335, age data 345, and reuse data 355 associated with the data (e.g., matrix block 117) loaded into a corresponding entry of a hardware buffer 128. As an example, a tracking entry 315 includes data representing the vector register addresses 226 from which the matrix block 117 stored in the entry was read, change data 335 indicating whether the matrix block 117 was modified before being loaded into the entry, age data 345 indicating when the matrix block 117 was loaded into the entry (e.g., a position in an order in which matrix blocks 117 were loaded into the hardware buffer 128), and reuse data 355 indicating whether the matrix block 117 loaded into the entry is to be reused by a subsequent instruction to be executed.

According to implementations, when scheduling circuitry 252 schedules an instruction 116 for execution, the scheduling circuitry 252 first determines the vector register addresses 226 indicated by the instruction 116 and sends one or more read requests to the vector registers 122 based on vector register addresses 226 indicated by the instruction 116. That is, the scheduling circuitry sends one or more read requests identifying vector register addresses 226 corresponding to the matrix blocks 117 indicated by the instruction 116. After reading one or more matrix blocks 117 from the vector registers 122, the scheduling circuitry 252 also sends a respective write request to the buffer control circuitry 242 identifying the data read out from the vector register addresses 226 indicated by the instruction 116. The buffer control circuitry 242 then loads this data indicated in the write request into respective hardware buffers 128 and updates corresponding tracking entries 315 based on the write request. Additionally, while the command processor 112 writes data representing the matrix blocks 117 of the instructions 116 to the vector registers 122, the buffer control circuitry 242 is configured to monitor (e.g., snoop) interconnection circuitry 354 for the write requests to the hardware buffers 232, 236, 244, 248 from the command processor 112. In response to a write request indicating that data written to be written to a hardware buffer 232, 236, 244, 248 is modified before being stored, the buffer control circuitry 242 will update the change data 335 of one or more tracking entries 315 to indicate that the matrix block 117 has been modified.

According to implementations, buffer control circuitry 242 is configured to evict entries from hardware buffers 128 based on the tracking sets 305. For example, when the buffer control circuitry 242 goes to load a matrix block 117 into a hardware buffer 128 that is full (e.g., a hardware buffer 128 where each entry already stores a matrix block 117), the buffer control circuitry 242 is configured to evict the data of an entry of the hardware buffer 128 based on the tracking set 305 associated with the hardware buffer 128. For example, in response to a hardware buffer 128 being full, the buffer control circuitry 242 first checks the tracking entries 315 of the tracking set 305 associated with the hardware buffer 128 to determine which tracking entries 315 include reuse data 355 indicating that a matrix block 117 is not to be reused. From each tracking entry 315 that includes reuse data 355 indicating that a matrix block 117 is not to be reused, the buffer control circuitry 242 determines the tracking entry 315 that includes age data 345 indicating the oldest data (e.g., the data that was loaded into an entry the earliest). The buffer control circuitry 242 then evicts the data from the entry of the hardware buffer 128 corresponding to the tracking entry 315 indicating the oldest data and stores the read out matrix block 117 into the entry. In response to none of the tracking entries 315 including reuse data 355 indicating that a matrix block 117 is not to be reused, the buffer control circuitry 242 determines the tracking entry 315 of the tracking set 305 that has age data 345 indicating the oldest entry (e.g., entry including data that was loaded the earliest). The buffer control circuitry 242 then evicts the data from the entry of the hardware buffer 128 corresponding to this tracking entry 315 and stores the read out matrix block 117 into the entry.

In implementations, scheduling circuitry 252 is configured to check the tracking entries 315 before sending a read request to vector registers 122. For example, when scheduling an instruction 116 for execution at a SIMD unit 230, the scheduling circuitry 252 compares the vector register addresses 226 indicated in the instruction 116 to be executed to the tracking sets 305 associated with the hardware buffers 128 of the SIMD unit 230. Based on the vector register addresses 226 indicated in the instruction 116 not matching the sets of vector register addresses 325 of any tracking entry 315 in the tracking sets 305, the scheduling circuitry 252 determines that the data (e.g., matrix block 117) to be read from the vector registers 122 is not already stored in the hardware buffers 128 and sends a read request to the vector registers 122 so as to provide data to a corresponding ALU circuitry 240. Further, based on the vector register addresses 226 indicating in the instruction 116 matching the set of vector register addresses 325 of a tracking entry 315 of a tracking set 305, the scheduling circuitry 252 determines whether the change data 335 of the matching tracking entry 315 indicates that the data (e.g., matrix block 117) was modified before being loaded into the entry of the hardware buffer 128 corresponding to the tracking entry 315. In response to the change data 335 indicating that the data was modified, the scheduling circuitry 252 determines that the data (e.g., matrix block 117) to be read from the vector registers 122 is not already stored in the hardware buffers 128 and sends a read request to the vector registers 122 so as to provide data to a corresponding ALU circuitry 240. Additionally, in response to the change data 335 indicating that the data was not modified, the scheduling circuitry 252 determines that the data (e.g., matrix block 117) is already loaded into an entry of the hardware buffer 128 corresponding to the tracking entry 315 and suppresses a read request such that a read request identifying the set of vector register addresses 325 in the matched tracking entry 315 is not sent to the vector registers 122. The hardware buffer 128 then provides the data stored in the entry of the hardware buffer 128 (e.g., the reused matrix block 117) corresponding to the match tracking entry 315 to a corresponding ALU circuitry 240. Because the scheduling circuitry 252 suppresses reads to the vector registers 122 in this way, the number of reads to the vector registers 122 is reduced which reduces the overall time and power needed to execute the instructions 116 and implement a corresponding machine-learning model 108.

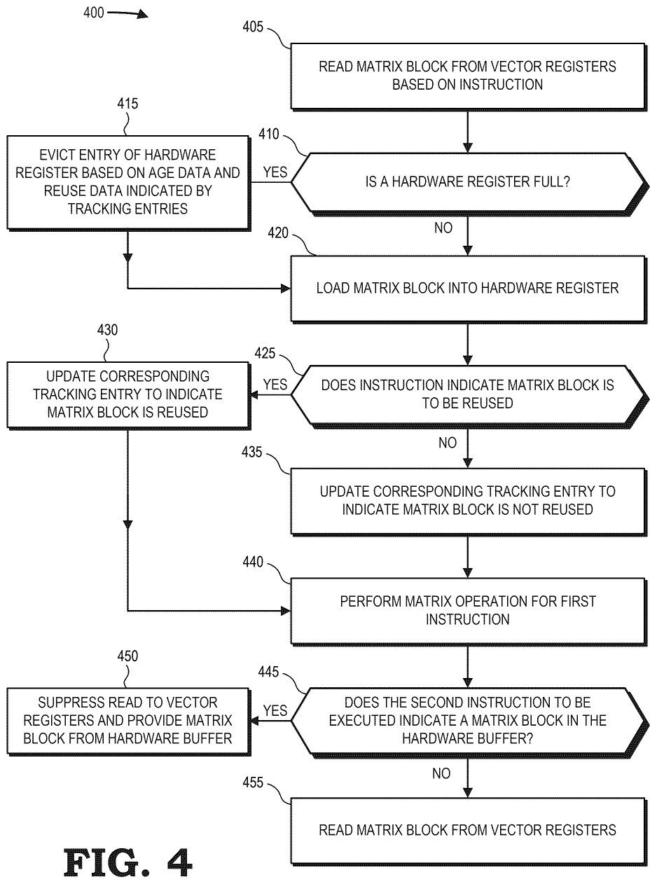

Referring now to FIG. 4, an example method 400 for matrix block buffering for matrix multiplication operations is presented, in accordance with implementations. According to implementations, example method 400 is implemented at least in part by AU 110. Example method 400 includes, at block 405, scheduling circuitry 252 of a core 114 scheduling an instruction 116 for execution at a SIMD unit 230. For example, the scheduling circuitry 252 first determines a set of vector register addresses 226 indicated in the instruction 116 that stores data representing a matrix block 117. The scheduling circuitry 252 then reads this matrix block 117 out of this set of vector register addresses 226 and provides the matrix block 117 to a corresponding ALU circuitry 240. Additionally, the scheduling circuitry 252 sends a write request to a corresponding buffer control circuitry 242 requesting that data representing the matrix block 117 be loaded into a hardware buffer 128 associated with the vector registers 122 from which the matrix block 117 was read. In response to receiving this write request, at block 410, the buffer control circuitry 242 determines whether the hardware buffer 128 is full. That is, whether each entry of the hardware buffer 128 already stores data representing a respective matrix block 117. Based on the hardware buffer 128 being full, at block 415, the buffer control circuitry 242 evicts data from an entry of the hardware buffer 128 based on the tracking set 305 associated with the hardware buffer 128. For example, the buffer control circuitry 242 first identifies the tracking entries 315 of the tracking set 305 that include reuse data 355 indicating that a matrix block 117 stored at a corresponding entry of the hardware buffer 128 is not to be reused. From these tracking entries 315 that include reuse data 355 indicating that a matrix block 117 stored at a corresponding entry of the hardware buffer 128 is not to be reused, the buffer control circuitry 242 determines the tracking entry 315 having age data 345 indicating the oldest entry. That is, the tracking entry 315 corresponding to an entry of the hardware buffer 128 that has the earliest loaded data. The buffer control circuitry 242 then evicts the data from the entry of the hardware buffer 128 corresponding to the tracking entry 315 having age data 345 indicating the oldest entry.

Further, still referring to block 415, in response to none of the tracking entries 315 in the tracking set 305 having reuse data 355 indicating a corresponding matrix block 117 is to be used, the buffer control circuitry 242 determines the tracking entry 315 having age data 345 indicating the oldest entry from all the tracking entries 315 in the tracking set 305. The buffer control circuitry 242 then evicts the data from the entry of the hardware buffer 128 corresponding to the tracking entry 315 having age data 345 indicating the oldest entry. At block 420, the buffer control circuitry 242 stores data representing the matrix block 117 read out at block 405 in a free (e.g., empty) entry of the hardware buffer 128. For example, the buffer control circuitry 242 stores data representing the matrix block 117 in the entry from which data was evicted at block 415. At block 425, the buffer control circuitry 242 updates the tracking entry 315 associated with the entry of the hardware buffer 128 in which data representing the matrix block 117 was loaded based on the scheduled instruction 116. For example, in response to the scheduled instruction 116 including a reuse indicator 109 that indicates the matrix block 117 of the instruction is to be reused, at block 430, the buffer control circuitry 242 updates the tracking entry 315 of the entry into which the matrix block 117 was loaded to indicate the set of vector registers 226 from which the matrix block 117 was read, whether the matrix block 117 was modified before being loaded into the hardware buffer 128, when the matrix block 117 was loaded into the hardware buffer 128 (e.g., a position in an order in which data was loaded into the hardware buffer 128), and that the matrix block 117 is to be reused. Additionally, in response to the scheduled instruction 116 including a reuse indicator 109 that indicates the matrix block 117 of the instruction is not to be reused, at block 435, the buffer control circuitry 242 updates the tracking entry 315 of the entry into which the matrix block 117 was loaded to indicate the set of vector registers 226 from which the matrix block 117 was read, whether the matrix block 117 was modified before being loaded into the hardware buffer 128, when the matrix block 117 was loaded into the hardware buffer, and that the matrix block 117 is not to be reused.

After updating the tracking entry 315 associated with the entry into which the matrix block 117 was loaded, at block 440, respective ALU circuitry 240 performs a matrix multiplication operation using the matrix block 117 read out from the vector registers 122. At block 445, the scheduling circuitry 252 is configured to schedule a subsequent instruction for execution. For example, the scheduling circuitry 252 first determines whether a matrix multiplication operation of the subsequent instruction uses a matrix block 117 loaded into the hardware buffers 128 associated with the SIMD unit 230. As an example, the scheduling circuitry 252 checks the tracking entries 315 of the tracking sets 305 corresponding to these hardware buffers 128 to determine whether any of these tracking entries 315 indicate the set of vector register addresses 226 identified in the subsequent instruction 116. Based on none of the tracking entries 315 indicating the same set of vector register addresses 226 as those identified in the subsequent instruction 116, the scheduling circuitry 252 determines that no matrix blocks 117 are reused and moves to block 455. Further, based on a tracking entry 315 indicating the same set of vector register addresses 226 as those identified in the subsequent instruction 116, the scheduling circuitry 252 then determines whether the change data 335 of the matched tracking entry 315 indicates that the matrix block 117 was modified before being loaded into the hardware buffer 128. In response to the change data 335 indicating that the matrix block 117 was changed, the scheduling circuitry 252 determines that no matrix blocks 117 are reused and moves to block 455. Further, in response to the change data 335 indicating that the matrix block 117 was not changed, the scheduling circuitry 252 determines that the matrix blocks 117 is reused and moves to block 450. At block 450, the scheduling circuitry 252 suppresses a read request for the matrix block 117 associated with the matched tracking entry 315 such that the read request is not sent to the vector registers 122. The hardware buffer 128 then provides data representing the matrix block 117 to the ALU circuitry 240 from the entry associated with the matched tracking entry 315. At block 455, the scheduling circuitry sends a read request for the matrix block 117 to the vector registers 122 and then provides the read-out matrix block 117 to the ALU circuitry 240.

In some implementations, the apparatus and techniques described above are implemented in a system including one or more integrated circuit (IC) devices (also referred to as integrated circuit packages or microchips), such as the AU described above with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some implementations, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. An accelerator unit (AU), comprising:
a plurality of vector registers configured to store data associated with a plurality of instructions;
a hardware buffer including a plurality of entries; and
a processor core configured to:
maintain a respective tracking entry for each entry of the plurality of entries of the hardware buffer; and
perform a matrix multiplication operation for an instruction of the plurality of instructions using a matrix block stored in an entry of the plurality of entries based on the tracking entry associated with the entry of the plurality of entries.

2. The AU claim 1, wherein the processor core is configured to:
read the matrix block from the plurality of vector registers based on a second instruction of the plurality of instructions; and
load the matrix block into the entry of the plurality of entries.

3. The AU of claim 2, wherein the processor core is configured to:
update the tracking entry to indicate a plurality of vector register addresses identified by the second instruction based on the matrix block being loaded into the entry of the plurality of entries.

4. The AU of claim 2, wherein the processor core is configured to:
evict the matrix block from the entry of the plurality of entries based on whether the tracking entry indicates the matrix block is to be reused by a subsequent instruction.

5. The AU of claim 1, wherein the processor core is configured to:
perform the matrix multiplication operation using the matrix block stored in the entry of the plurality of entries based on the tracking entry associated with the entry of the plurality of entries indicating a set of vector register addresses identified in the instruction.

6. The AU of claim 1, wherein the instruction indicates whether the matrix block is to be reused by a subsequent instruction.

7. The AU of claim 6, wherein the processor core is configured to:
update the tracking entry associated with the entry of the plurality of entries to indicate that the matrix block is to be reused.

8. A method, comprising:
maintaining, by a processor core, a respective tracking entry for each entry of a plurality of entries of a hardware buffer associated with the processor core; and
performing, by the processor core, a matrix multiplication operation for an instruction using a matrix block stored in an entry of the plurality of entries based on the tracking entry associated with the entry of the plurality of entries.

9. The method of claim 8, further comprising:
reading the matrix block from a plurality of vector registers based on a second instruction; and
loading the matrix block into the entry of the plurality of entries.

10. The method of claim 9, further comprising:
updating the tracking entry to indicate a plurality of vector register addresses identified by the second instruction based on the matrix block being loaded into the entry of the plurality of entries.

11. The method of claim 9, further comprising:
evicting the matrix block from the entry of the plurality of entries based on whether the tracking entry indicates the matrix block is to be reused by a subsequent instruction.

12. The method of claim 8, further comprising:
performing the matrix multiplication operation using the matrix block stored in the entry of the plurality of entries based on the tracking entry associated with the entry of the plurality of entries indicating a set of vector register addresses identified in the instruction.

13. The method of claim 8, wherein the instruction indicates whether the matrix block is to be reused by a subsequent instruction.

14. The method of claim 13, further comprising:
updating the tracking entry associated with the entry of the plurality of entries to indicate that the matrix block is to be reused.

15. An accelerator unit (AU), comprising:
a plurality of vector registers;
a hardware buffer including a plurality of entries; and
a processor core configured to:
maintain a respective tracking entry for each entry of the plurality of entries of the hardware buffer;
provide a matrix block for an instruction to arithmetic logic unit (ALU) circuitry by sending a read request to the plurality of vector registers based on whether vector register addresses indicated in the instruction match a set of vector register addresses in a tracking entry corresponding to an entry of the plurality of entries; and
perform, by the ALU circuitry, a matrix multiplication operation using the matrix block.

16. The AU of claim 15, wherein the processor core is configured to:
evict data from an entry of the plurality of entries in response to the tracking entry associated with the entry indicating the matrix block is not to be reused.

17. The AU of claim 15, wherein the processor core is configured to:
send the read request to the plurality of vector registers based on the vector register addresses indicated by the instruction not matching a set of vector register addresses of any tracking entry.

18. The AU of claim 15, wherein the processor core is configured to:
suppress the read request to the plurality of vector registers so that the read request is not sent based on the vector register addresses indicated by the instruction matching the set of vector register addresses of a tracking entry.

19. The AU of claim 15, wherein each tracking entry further indicates whether the matrix block was changed before being loaded into the hardware buffer.

20. The AU of claim 19, wherein the instruction indicates whether the matrix block is to be reused by a subsequent instruction.
